(19) United States
(12) Patent Application Publication
(10) Pub. No.: US 2025/0187323 A1
(43) Pub. Date: Jun. 12, 2025

(54) INTERIOR TRIM ELEMENT FOR A MOTOR VEHICLE

(71) Applicant: TREVES PRODUCTS,SERVICES & INNOVATION, Issy- Les -Moulineaux (FR)

(72) Inventor: Stephane RIBES, Issy-Les-Moulineaux (FR)

(21) Appl. No.: 18/845,904

(22) PCT Filed: Mar. 21, 2023
(86) PCT No.: PCT/EP2023/057148

§ 371 Date: Sep. 11, 2024

(30) Foreign Application Priority Data
Mar. 24, 2022 (FR) 2202649

(51) Int. Cl. B32B 37/15; B32B 5/02; B32B 5/18; B32B 5/24; B32B 5/26; B32B 27/06; B32B 27/12; B32B 27/20

(52) U.S. Cl. CPC B32B 37/153; B32B 5/02; B32B 5/18; B32B 5/245; B32B 5/26; B32B 27/065; B32B 27/12; B32B 27/20; B32B 2262/12; B32B 2305/72; B32B 2307/102; B32B 2307/546; B32B 2307/718; B32B 2398/20; B32B 2605/003

(57) ABSTRACT

The invention relates to an interior trim element (1) for a motor vehicle comprising a complex (2) having an upper coating layer (3) based on thermoplastic material and a lower support layer (4) associated with said coating layer, said support layer having a minimum mass per unit area of 400 g/m² and being based either on a porous fibrous material or on a leak-tight flexible plastic material provided with a mineral filler representing at least 50% by mass of said support layer, said coating layer comprising at least 85% by mass of vulcanized thermoplastic (TPV) and having a mass per unit area of less than 600 g/m².

The invention relates to an interior trim element for a motor vehicle.

It is known to produce an interior trim element for a motor vehicle—such as a carpet or a door trim panel—, said element comprising a multilayer complex, said complex comprising:
an upper coating layer based on thermoplastic material,
a lower support layer associated with said coating layer, said support layer having a minimum mass per unit area of 400 g/m² and being based on:
   either a porous fibrous material,
   or a leak-tight flexible plastic material provided with a mineral filler representing at least 50% by mass of said support layer.

Usually, a support layer based on a leak-tight plastic material, as mentioned above, is arranged on an elastically compressible spring layer so that the element provides acoustic insulation based on a “mass/spring” principle.

A number of requirements need to be taken into account when designing a trim element as described above.

In particular, the coating layer must have:
a minimized mass, as this layer is often based on an expensive material,
minimized gloss, so as to give it an attractive appearance,
high polarity (high surface tension), so as to adhere strongly to the support layer,
optionally an extrusion capability, for its deposition by extrusion followed by calendering on the support layer,
optionally, the possibility to be made from recycled materials, so as to minimize cost and environmental impact.

The aim of the invention is to propose a trim element that takes these various constraints into account.

To this end, and according to a first aspect, the invention proposes an interior trim element for a motor vehicle, said element comprising a multilayer complex, said complex comprising:
an upper coating layer based on thermoplastic material,
a lower support layer associated with said coating layer, said support layer having a minimum mass per unit area of 400 g/m² and being based on:
   either a porous fibrous material,
   or a leak-tight flexible plastic material with a mineral filler representing at least 50% by mass of said support layer,
      said coating layer:
comprising at least 85% by mass of vulcanized thermoplastic (TPV),
having a mass per unit area of less than 600 g/m².

In this description, the spatial positioning terms (upper, lower, below, . . . ) are taken to refer to the trim element installed in the vehicle.

Vulcanized thermoplastics (VTP) are two-phase olefinic materials (alloys) comprising:
a rigid polypropylene phase (homopolymer and/or copolymer),
and a flexible phase cross-linked with ethylene propylene diene monomer (EPDM).

With the proposed arrangement, the presence of TPV in the coating layer enables:
to minimize its mass, thanks to the very high abrasion resistance of TPV, which enables the layer to be made in very thin thickness,
to minimize its gloss, as TPV is matte in nature,
to maximize its polarity, TPV being a highly polar material,
to give it good capability for extrusion, especially in thin thickness, since TPV itself has good capability for extrusion,
the use of recycled materials, as the TPV itself can be made from recycled materials.

Further features and advantages of the invention will become apparent from the following description, made with reference to the attached figures, in which:

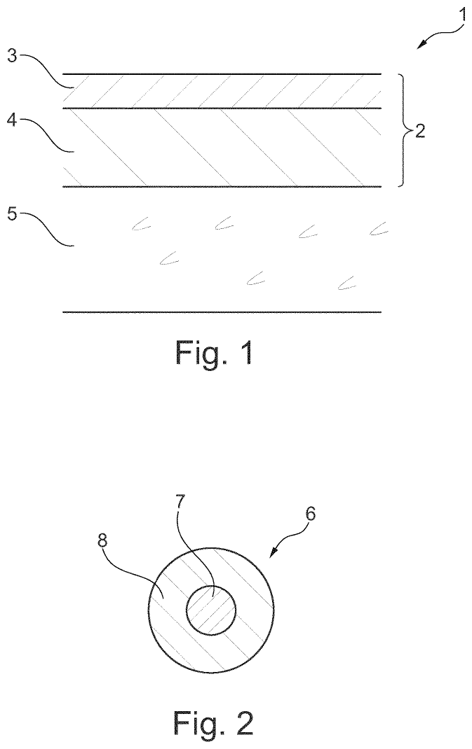

FIG. 1 is a schematic partial cross-sectional view of an element in one embodiment,
FIG. 2 is a schematic cross-section view of a two-component bonding fiber.

With reference to the figures, an interior trim element 1 for a motor vehicle-such as a carpet or a door trim panel-is described, said element comprising a multilayer complex 2, said complex comprising:
an upper coating layer 3 based on thermoplastic material,
a lower support layer 4 associated with said coating layer, said support layer having a minimum mass per unit area of 400 g/m² and being based on:
   either a porous fibrous material—e.g. needle felt—,
   or a leak-tight flexible plastic material—e.g. an elastomer (e.g. ethylene propylene diene monomer, etc.), a plastomer, ethylene vinyl acetate mixed with polyethylene, etc.—provided with a mineral filler representing at least 50%—in particular at least 75%—by mass of said support layer,
      said coating layer:
comprising at least 85% by mass of vulcanized thermoplastic (TPV),
having a mass per unit area of less than 600 g/m².

In one embodiment, the coating layer 3 further comprises less than 15% by mass of dispersed filler (e.g. calcium carbonate), so as to lower its cost while maintaining good resistance of said layer to abrasion.

In one embodiment, the coating layer 3:
has a mass per unit area of between 300 and 400 g/m², so as to minimize the use of vulcanized thermoplastics (TPV),
is extruded and then calendered onto the support layer 4.

Minimizing the use of TPV is motivated in particular by economic considerations, as TPV is an expensive product.

To further minimize the economic impact of using such a product and to promote an environmental approach, it is advantageous to use recycled TPV.

It should be noted that TPV exhibits good hot adhesion, its surface tension at room temperature already being greater than 45 dyn according to ISO 8296:2003 standard.

As a result, TPV has a great capability for lamination on a support layer 4, to which it adheres strongly.

In addition, the very good abrasion resistance of TPV allows the coating layer 3 to be deposited in a very thin layer on the support layer 4, said support layer allowing the shape of said coating layer to be maintained despite its thinness.

According to various embodiments, the coating layer 3 can be grained on its appearance face, either before or after its association with the support layer 4.

According to the embodiment shown in FIG. 1, the support layer 4 is based on a leak-tight flexible plastic material provided with a mineral filler representing at least 50% by mass of said layer, the element 1 further comprising an elastically compressible spring layer 5 arranged below said support layer, so that said element forms a “mass/spring” type acoustic insulation system, the mass layer of said system being formed by the complex 2.

The spring layer 5 is based in particular on:
an elastically compressible foam, in particular polyurethane, with in particular a density of between 50 and 100 g/m³,
or a porous fibrous material, such as needle felt,
or a mixture of elastically compressible foam flakes (e.g. made of polyurethane) bonded together by bi-component bonding fibers 6, said bonding fibers comprising a core 7 with a high melting point (e.g. made of polyester) and a sheath 8 with a lower melting point (e.g. made of modified polyester), the melting of said sheath ensuring the bonding of said flakes together.

1. Interior trim element (1) for a motor vehicle, said element comprising a multilayer complex (2), said complex comprising:
an upper coating layer (3) based on thermoplastic material,
a lower support layer (4) associated with said coating layer, said support layer having a minimum mass per unit area of 400 g/m² and being based on:
either a porous fibrous material,
or a leak-tight flexible plastic material provided with a mineral filler representing at least 50% by mass of said support layer,
said element being characterized in that said coating layer:
comprises at least 85% by mass of vulcanized thermoplastic (TPV),
has a mass per unit area of less than 600 g/m².

2. Element according to claim 1, characterized in that the coating layer (3) further comprises less than 15% by mass of dispersed filler, so as to maintain good abrasion resistance.

3. Element according to claim 1, characterized in that the coating layer (3):
has a mass per unit area of between 300 and 400 g/m², so as to minimize the use of vulcanized thermoplastics (TPV),
is extruded and then calendered onto the support layer (4).

4. Element according to claim 1, characterized in that, when the support layer (4) is based on a leak-tight flexible plastic material provided with a mineral filler representing at least 50% by mass of said layer, said element further comprises an elastically compressible spring layer (5) arranged below said support layer, so that said element forms a “mass/spring” type acoustic insulation system, the mass layer of said system being formed by the complex (2).

5. Element according to claim 4, characterized in that the spring layer (5) is based on:
an elastically compressible foam,
or a porous fibrous material,
or a mixture of elastically compressible foam flakes bonded together by bi-component bonding fibers (6), said bonding fibers comprising a core (7) with a high melting point and a sheath (8) with a lower melting point, the melting of said sheath ensuring the bonding of said flakes together.
